(19) United States
(12) Patent Application Publication
(10) Pub. No.: US 2013/0035938 A1
(43) Pub. Date: Feb. 7, 2013

(54) APPARATUS AND METHOD FOR RECOGNIZING VOICE

(71) Applicant: Ho Young Jung, Daejeon (KR)

(72) Inventor: Ho Young Jung, Daejeon (KR)

(73) Assignee: ELECTRONICS AND COMMUNICATIONS RESEARCH INSTITUTE, Daejeon (KR)

(21) Appl. No.: 13/540,047

(22) Filed: Jul. 2, 2012

(30) Foreign Application Priority Data
Aug. 1, 2011 (KR) 10-2011-0076620

(51) Int. Cl. G10L 15/04

(52) U.S. Cl. 704/251; 704/E15.005

(57) ABSTRACT

The present invention includes a hierarchical search process. The hierarchical search process includes three steps. In a first step, a word boundary is determined using a recognition method of determining a following word dependent on a preceding word, and a word boundary detector. In a second step, word unit based recognition is performed in each area by dividing an input voice into a plurality of areas based on the determined word boundary. Finally, in a third step, a language model is applied to induce an optimal sentence recognition result with respect to a candidate word that is determined for each area. The present invention may improve the voice recognition performance, and particularly, the sentence unit based consecutive voice recognition performance.

### CROSS-REFERENCE TO RELATED APPLICATIONS

This application claims priority to and the benefit of Korean Patent Application No. 10-2011-0076620 filed in the Korean Intellectual Property Office on Aug. 1, 2011, the entire contents of which are incorporated herein by reference.

### TECHNICAL FIELD

The present invention relates to an apparatus and a method for recognizing a voice, and more particularly, to an apparatus and a method for recognizing a consecutive voice.

### BACKGROUND ART

The following method has been proposed as one of the related arts for consecutive voice recognition. Initially, a predetermined word is determined starting from a start point of an input voice. Next, a following word is determined by combining acoustic scores and linguistic scores that indicate correlation with a preceding word. Next, a single recognition path is determined by sequentially repeating the following word determination. The above method suggests, as a sentence recognition result, a recognition path having the highest scores among a plurality of recognition paths. However, according to the above method, a substantial boundary between words becomes unclear and there is no explicit methodology of combining acoustic scores and linguistic scores. It is possible to be aware of only correlation with a preceding word that is determined based on linguistic knowledge and thus, it is difficult to use backward linguistic knowledge and long-term language information.

### SUMMARY OF THE INVENTION

The present invention has been made in an effort to provide a voice recognition apparatus and method that generate a candidate word by detecting a word boundary, dividing an input voice into a plurality of areas, and performing word unit based recognition in each area, and finally perform sentence recognition by combining linguistic knowledge.

An exemplary embodiment of the present invention provides an apparatus for recognizing a voice, including: an input voice divider to divide an input voice into sentence component groups, each group including at least one word; a word recognizer to recognize a word included in each group for each divided sentence component group; a candidate word extractor to extract, from recognized words as a candidate word, a word that matches a sentence configuration word constituting a sentence; and a sentence recognizer to perform sentence unit based voice recognition with respect to the input voice based on extracted candidate words.

The input voice divider may include: a word extractor to sequentially extract the word from the input voice based on an input order; a boundary point determining unit to determine, as a boundary point, a single point that is positioned between extracted words; a boundary point selector to select, from among determined boundary points, a boundary point that matches a predetermined boundary detection model; and a sentence component group divider to divide the input voice into sentence component groups based on the selected boundary point. The boundary point selector may use a noise component or a channel variation component as the boundary detection model.

The candidate word extractor may include: a reliability calculator to calculate a reliability value based on an anti-phoneme model with respect to each of the recognized words; and a reliability based word extractor to extract, as the candidate word, a word whose calculated reliability value is greater than or equal to a reference value.

The sentence recognizer may include: a candidate word combiner to combine candidate words; and a sentence generator to perform the sentence unit based voice recognition with respect to the input voice by generating, as a sentence, a combination that matches a language model based on a sentence configuration principle among combinations of candidate words. The candidate word combiner may include: a candidate word arrangement unit to arrange the candidate words based on an extraction order; and an arranged word combiner to forward combine the arranged candidate words based on the extraction order, to backward combine the arranged candidate words based on the extraction order, or to combine the arranged candidate words regardless of the extraction order.

The sentence recognizer may perform the sentence unit based voice recognition with respect to the input voice that is consecutively input.

Another exemplary embodiment of the present invention provides a method of recognizing a voice, including: an input voice dividing step of dividing an input voice into sentence component groups, each group including at least one word; a word recognizing step of recognizing a word included in each group for each divided sentence component group; a candidate word extraction step of extracting, from recognized words as a candidate word, a word that matches a sentence configuration word constituting a sentence; and a sentence recognizing step of performing sentence unit based voice recognition with respect to the input voice based on extracted candidate words.

The input voice dividing step may include: a word extracting step of sequentially extracting the word from the input voice based on an input order; a boundary point determining step of determining, as a boundary point, a single point that is positioned between extracted words; a boundary point selecting step of selecting, from among determined boundary points, a boundary point that matches a predetermined boundary detection model; and a sentence component group dividing step of dividing the input voice into sentence component groups based on the selected boundary point. The boundary point selecting step may use a noise component or a channel variation component as the boundary detection model.

The candidate word extracting step may include: a reliability calculating step of calculating a reliability value based on an anti-phoneme model with respect to each of the recognized words; and a reliability based word extracting step of extracting, as the candidate word, a word whose calculated reliability value is greater than or equal to a reference value.

The sentence recognizing step may include: candidate word combining step of combining candidate words; and a sentence generating step of performing the sentence unit based voice recognition with respect to the input voice by generating, as a sentence, a combination that matches a language model based on a sentence configuration principle among combinations of candidate words. The candidate word combining step may include: a candidate word arranging step of arranging the candidate words based on an extraction order; and an arranged word combining step of forward combining the arranged candidate words based on the extraction order, backward combining the arranged candidate words based on the extraction order, or combining the arranged candidate words regardless of the extraction order.

The sentence recognizing step may perform the sentence unit based voice recognition with respect to the input voice that is consecutively input.

According to exemplary embodiments of the present invention, it is possible to obtain the following effects. First, it is possible to improve the sentence unit based consecutive voice recognition performance by performing a hierarchical search method. The hierarchical search method proceeds through a first step of detecting a word boundary and dividing an input voice into a plurality of areas, a second step of generating a candidate word by performing a word unit based recognition in each area, a third step of finally performing a sentence recognition by combining linguistic knowledge, and the like. Second, by performing the hierarchical search method, a boundary between words becomes clear and a language model is applied beyond correlation between a preceding word and a following word and thus, it is possible to use long-term language information and backward language information. It may contribute to improving the sentence recognition performance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating a voice recognition apparatus according to an exemplary embodiment of the present invention.

FIGS. 2A through 2D are block diagrams illustrating in detail an internal configuration of a voice recognition apparatus according to the present exemplary embodiment.

FIG. 3 is a diagram illustrating a sentence unit based voice recognition process through a hierarchical search structure.

FIG. 4 is a flowchart of a hierarchical search process for consecutive voice recognition.

FIG. 5 is a flowchart schematically illustrating a voice recognition method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

Disclosed are a voice recognition apparatus and method proposed to improve the performance of sentence unit based consecutive voice recognition. The present invention includes a hierarchical search process. The hierarchical search process includes three steps. In a first step, a word boundary is determined using a recognition method of determining a following word dependent on a preceding word, and a word boundary detector. In a second step, word unit based recognition is performed in each area by dividing an input voice into a plurality of areas based on the determined word boundary. Finally, in a third step, a language model is applied to induce an optimal sentence recognition result with respect to a candidate word that is determined for each area. The present invention may improve the voice recognition performance, and particularly, the sentence unit based consecutive voice recognition performance.

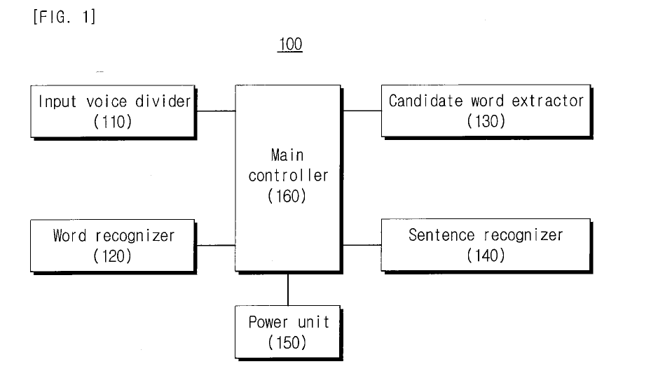

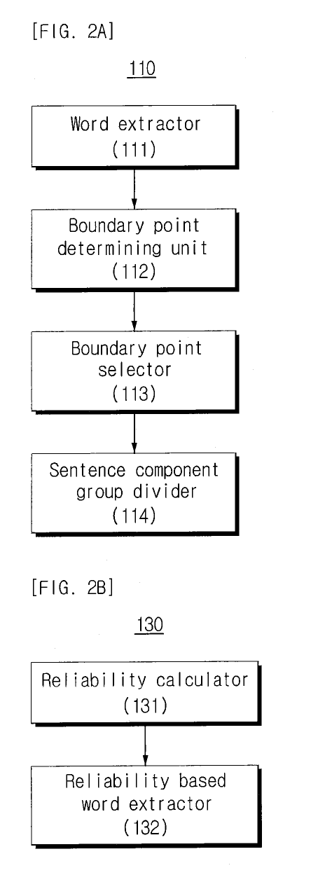

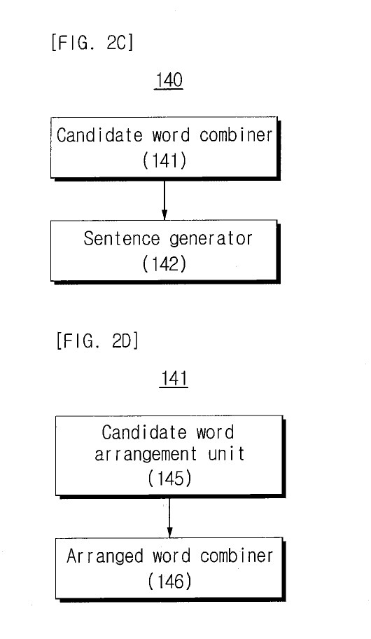

FIG. 1 is a block diagram schematically illustrating a voice recognition apparatus according to an exemplary embodiment of the present invention. FIGS. 2A through 2D are block diagrams illustrating in detail an internal configuration of a voice recognition apparatus according to the present exemplary embodiment. Hereinafter, a description will be made with reference to FIGS. 1 to 2D.

Referring to FIG. 1, a voice recognition apparatus 100 performs sentence unit based voice recognition, and includes an input voice divider 110, a word recognizer 120, a candidate word extractor 130, a sentence recognizer 140, a power unit 150, and a main controller 160.

Compared to the word unit based recognition performance, the sentence unit based consecutive voice recognition performance has a relatively low characteristic. With respect to the same number of vocabulary sets to be recognized, a word unit based recognition rate shows a relatively high result compared to a word recognition rate in a sentence unit. This is attributed to limit of a current recognition methodology and may be because of a sequential method of not finding an accurate boundary of a word unit with respect to a sentence input, recognizing a single predetermined word while proceeding from a start point of a voice, and determining a following word unit on the recognized predetermined word. Since application of a language model indicating linguistic correlation to improve the performance of voice recognition is used only as additional information in sequential word determination, there is difficulty in combining long-term linguistic knowledge. The voice recognition apparatus 100 is proposed to solve the above problems and induces a final recognition result by determining a word boundary with respect to a sentence unit based voice input and dividing an area using the input voice divider 110, by determining N candidate words through word unit based voice recognition for each area using the word recognizer 120 and the candidate word extractor 130, and then by applying various language models to connect a candidate word determined for each area using the sentence recognizer 140. The input voice divider 110 primarily determines a word boundary using a method of determining a following word depending on a preceding word and then finally confirms the word boundary using a detector of determining the word boundary. The word recognizer 120 and the candidate word extractor 130 determine N candidate words by performing word unit based voice recognition for each area that is identified based on the confirmed word boundary. The sentence recognizer 140 uses linguistic scores when combining words for each area for sentence configuration. Since the voice recognition apparatus 100 uses the hierarchical search structure, consecutive voice recognition is possible and it is also possible to use a long-term language model.

The input voice divider 110 functions to divide the input voice into sentence component groups, each group including at least one word. As shown in FIG. 2A, the input voice divider 110 may include a word extractor 111, a boundary point determining unit 112, a boundary point selector 113, and a sentence component group divider 114. The word extractor 111 functions to sequentially extract the word from the input voice based on an input order. The boundary point determining unit 112 functions to determine, as a boundary point, a single point that is positioned between extracted words. The boundary point selector 113 functions to select, from among determined boundary points, a boundary point that matches a predetermined boundary detection model. The boundary point selector 113 may use a noise component or a channel variation component as the boundary detection model. The sentence component group divider 114 functions to divide the input voice into the sentence component groups based on the selected boundary point.

The word recognizer 120 functions to recognize a word included in each group for each divided sentence component group.

The candidate word extractor 130 functions to extract, from recognized words as a candidate word, a word that matches a sentence configuration word constituting a sentence. As shown in FIG. 2B, the candidate word extractor 130 may include a reliability calculator 131 and a reliability based word extractor 132. The reliability calculator 131 functions to calculate a reliability value based on an anti-phoneme model with respect to each of the recognized words. The reliability based word extractor 132 functions to extract, as the candidate word, a word whose calculated reliability value is greater than or equal to a reference value.

The sentence recognizer 140 functions to perform sentence unit based voice recognition with respect to the input voice based on extracted candidate words. In the present exemplary embodiment, the sentence recognizer 140 performs the sentence unit based voice recognition with respect to the input voice that is consecutively input. As shown in FIG. 2C, the sentence recognizer 140 may include a candidate word combiner 141 and a sentence generator 142. The candidate word combiner 141 functions to combine candidate words. The sentence generator 142 functions to perform the sentence unit based voice recognition with respect to the input voice by generating, as a sentence, a combination that matches a language model based on a sentence configuration principle among combinations. shown in FIG. 2D, the candidate word combiner 141 may include a candidate word arrangement unit 145 and an arranged word combiner 146. The candidate word arrangement unit 145 functions to arrange the candidate words based on an extraction order. The arranged word combiner 146 functions to forward combine the arranged candidate words based on the extraction order, to backward combine the arranged candidate words based on the extraction order, or to combine the arranged candidate words regardless of the extraction order.

The power unit 150 functions to supply power to each of constituent elements that constitute the voice recognition apparatus 100.

The main controller 160 functions to control the overall operation of each of the constituent elements that constitute the voice recognition apparatus 100.

Characteristics of the above-described voice recognition apparatus 100 are arranged as follows. First, in the sentence unit based consecutive voice recognition, the voice recognition apparatus 100 performs consecutive voice recognition based on hierarchical search that includes three steps, a step of detecting a word boundary, a step of determining a candidate word through word unit based recognition for each area, and a step of inducing a final recognition result by combining candidate words for each area using a language model. Second, the voice recognition apparatus 100 identifies a final word boundary and an area by applying a word boundary detector around a boundary based on the word boundary of the consecutive voice recognition. Third, in the word boundary detection, the voice recognition apparatus 100 defines and models an acoustic characteristic specialized for the word boundary and determines the word boundary based on a reliability criterion using a word boundary model. Fourth, the voice recognition apparatus 100 determines N candidate words for each area by performing word unit based voice recognition for each of the areas that are divided with respect to a sentence unit based voice input. Fifth, when determining N candidate words for each area, the voice recognition apparatus 100 determines a ranking of a candidate word by obtaining the reliability criterion instead of obtaining a quantitative probability value of each word. Sixth, when determining a final sentence recognition result by combining N candidate words determined for each word boundary section, the voice recognition apparatus 100 performs the consecutive voice recognition in a structure of maximally using language knowledge by applying a backward language model as well as a forward language model and by applying a long-term language model.

To improve the performance of sentence unit based consecutive voice recognition, the voice recognition apparatus 100 of FIG. 1 includes a hierarchical search process, which is different from a consecutive voice recognition method according to a related art. The hierarchical search process includes three steps. In a first step, a word boundary is determined using a recognition method of determining a following word depending on a preceding word, and a word boundary detector. In a second step, word unit based recognition is performed in each area by dividing an input voice into a plurality of areas based on the determined word boundary. Finally, in a third step, a language model is applied to induce an optimal sentence recognition result with respect to a candidate word that is determined for each area.

The conventional method proposed with regards to voice recognition sequentially determines a single word from the moment when a voice starts, without clearly verifying a word boundary, and applies linguistic scores to acoustic scores of a following word depending on the determined word. Accordingly, when the preceding word is erroneously recognized, a following word string is highly likely to be also erroneously recognized. The reason why is because a language model applied to determine the following word depends on the preceding word. When combining acoustic scores and linguistic scores, each weight is used as a fixed value based on experience and thus, it adversely affects a process of sequentially determining a word. When performing voice recognition in noisy environment, a word boundary becomes unclear due to noise. A trained model and input noise voice do not match and thus, a recognition error frequently occurs and a recognition rate of a following word, which sequentially proceeds, significantly decreases.

To solve the above problems, the present invention proposes a hierarchical search method in three steps. In the word boundary determination that is performed in the first step, when a word boundary becomes unclear and a recognition error occurs due to noise and a channel variation, it is possible to increase an accuracy of a word boundary using a boundary detector. By dividing an area based on the word boundary determined in the first step and performing word unit based recognition for each area in the second step, recognition of a following word may be irrelevantly performed even though a preceding word is erroneously recognized. When determining a sentence using N candidate words for each area in the third step, linguistic scores are applied. Accordingly, it is possible to obtain effect of separating acoustic scores and linguistic scores from each other and thus, it is possible to eliminate a disadvantage occurring when combining acoustic scores and linguistic scores.

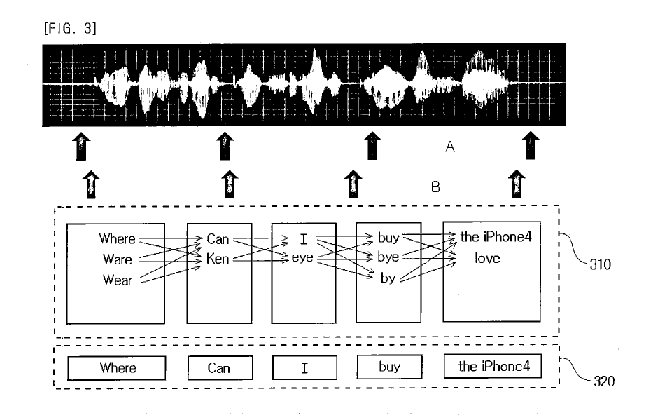

FIG. 3 is a diagram illustrating a sentence unit based voice recognition process through a hierarchical search structure.

The word boundary determination of the first step primarily finds a primary boundary using a recognition method of determining a following word depending on a preceding word (A), and finally determines an actual word boundary by applying a word boundary detector while performing adjustment to the left and right based on the found boundary (B). In FIG. 3, A indicates the word boundary extraction using the consecutive voice recognition by the above recognition method, and B indicates the final boundary extraction using the word boundary detector.

The word unit based voice recognition of the second step uses an existing word recognition technology as is. Boundary information of the first step is divided for each area and word recognition is performed for each area and thus, it is possible to obtain high performance compared to the consecutive voice recognition. In general, in the case of sentence recognition with respect to 200,000 vocabularies, a word recognition rate reaches around 70%. On the other hand, in the case of word recognition, 90% of a recognition rate is obtained. This is because the consecutive voice recognition provides a result along a sentence unit based optimal recognition path due to the unawareness of the number of words constituting a sentence. On the other hand, when recognition is dividedly performed for each area, it is possible to be aware of a single word and thus, the recognition performance may be significantly improved. Even though a preceding word is erroneously recognized, it does not affect recognition in a subsequent area.

Finally, a process of combining word strings having high linguistic scores by generating a sentence using N candidate words that are determined for each area and by combining linguistic knowledge is applied to the sentence recognition result inducement of the third step. It is possible to obtain the effect of separating acoustic scores and linguistic scores from each other. There is an advantage in that a person may recognize an acoustic phonetic value and then, easily imitate a process of combining words. When an unregistered word that is not registered to a recognition engine is included in a sentence, it adversely affects a sequential recognition process. On the other hand, when a three-step search structure is applied, it does not adversely affect the following word recognition even though the unregistered word is included in the sentence. In FIG. 3, a dotted box 310 shows candidate words for each area, and a dotted box 320 shows a final sentence recognition result induced by combining candidate word reliability and language model scores.

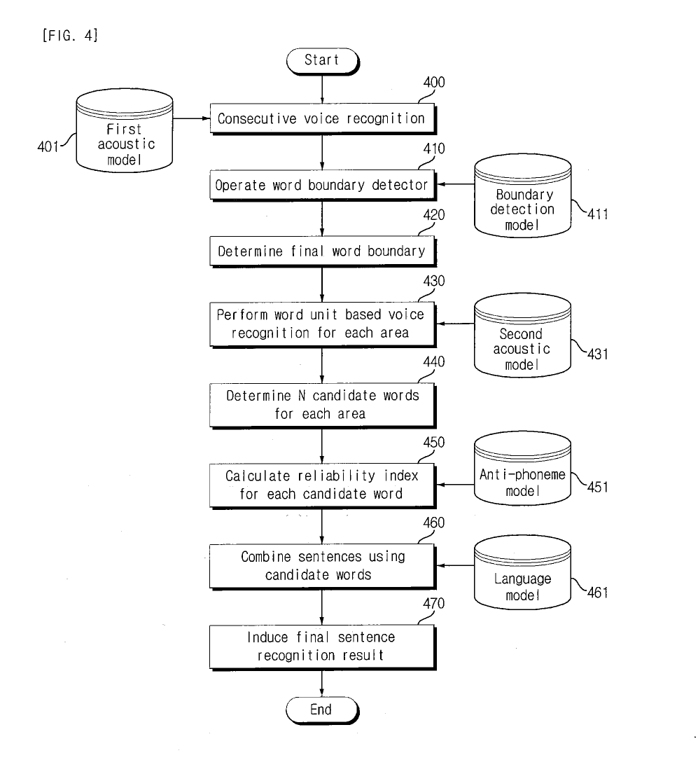

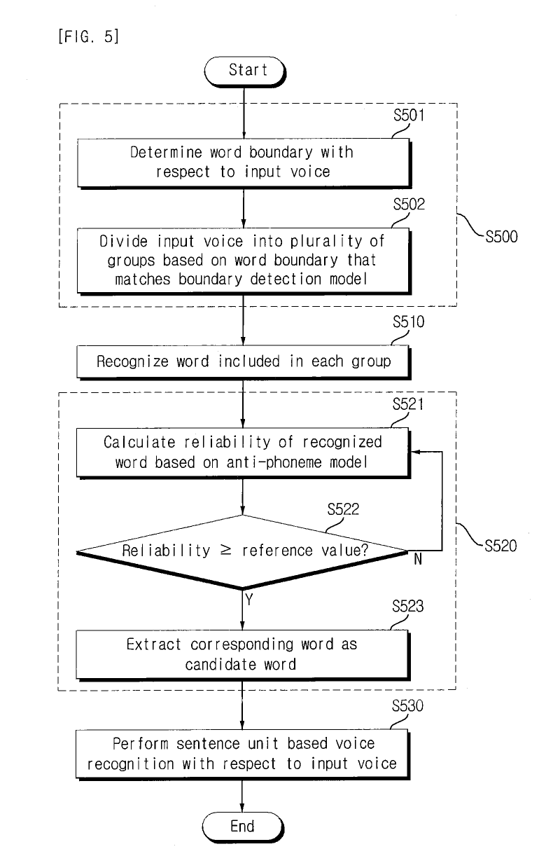

FIG. 4 is a flowchart of a hierarchical search process for consecutive voice recognition. Steps 400 through 420 are performed by a consecutive voice recognizer and a word boundary detector, and steps 430 and 440 are performed by a word unit based voice recognizer. Steps 460 and 470 are performed by a sentence combiner using a language model.

The consecutive voice recognizer performs consecutive voice recognition by referring to an existing first acoustic model 401 (400). Here, the consecutive voice recognition indicates a recognition method of determining a following word depending on a preceding word. When recognition is performed based on the consecutive voice recognition, a recognized word string and a corresponding time section of each word are determined. This time section may not match an actual time section. In FIG. 3, an arrow positioned on the left of A shows the example. Accordingly, in the present exemplary embodiment, a word boundary is adjusted using the word boundary detector.

The word boundary detector determines a final boundary while moving left and right based on a word boundary found in the consecutive voice recognition. A description relating thereto is made above through A and B in FIG. 3. The consecutive voice recognizer finds a word string constituting an input voice and thus, informs only an approximate section instead of informing even an accurate word section. Accordingly, in the present exemplary embodiment, the final boundary is extracted by applying the word boundary detector based on information about each section of a recognized word string after recognizing the word string using the consecutive voice recognizer.

The word boundary detector defines an acoustic characteristic specialized for a word boundary in addition to a characteristic for recognition, and configures a statistical model thereof (410). When a probability value is greater than or equal to a threshold value, the word boundary detector determines the final boundary as the word boundary (420). The word boundary detector more accurately detects an actual word boundary through energy, determination of voiced/unvoiced sound, determination of mute, a noise model, and the like. Energy, identification of mute, identification of voiced sound, determination of noise, and the like are applied to find a short pause section between the respective words. When configuring the statistical model, the word boundary detector may use the statistical model pre-stored in a boundary detection model 411.

When performing word unit based voice recognition for each area (430), a second acoustic model 431 may be used. The second acoustic model 431 includes the same acoustic model as the first acoustic model 401.

Step 440 indicates a step in which N candidate words are determined for each area. When the number of words is found and a boundary of each word is extracted through the above recognition process, a single word is present for each section and thus, an isolated word recognizer is applied instead of the consecutive voice recognizer. As the word recognition result for each section as above, N candidates are determined. In the infinite voice recognition, the consecutive voice recognizer determines a word string and at the same time, finds the number of words. Accordingly, compared to the isolated word recognizer of recognizing only a single fixed word, the recognition performance is significantly degraded.

Step 450 indicates a step in which a reliability index is calculated for each candidate word. When calculating the reliability index, an anti-phoneme model 451 may be used. The anti-phoneme model 451 indicates having a statistical characteristic opposite to a predetermined phoneme. For example, when a model is generated using data of phoneme “a”, and when a model is generated using data of phonemes having different characteristics from the characteristic of “a”, the models are referred to as a “a” phoneme model and a “a” anti-phoneme model, respectively. Accordingly, when pronouncing “a”, a probability value difference between the “a” phoneme model and the “a” anti-phoneme model is great. When pronouncing “b”, a probability value difference between the “a” phoneme model and the “a” anti-phoneme model decreases compared to the above case. Accordingly, the reliability of the recognition result may be calculated to be high according to an increase in a difference between a corresponding phoneme model and an anti-phoneme model with respect to the recognize result.

The sentence combiner functions to generate a sentence using N candidate words recognized with respect to areas divided along a boundary, and combines sentence having highest linguistic scores based on a language model 461 (460). Here, the sentence combination indicates combining a word string becoming a speech using the language model 461 when N candidates are determined with respect to each word section. That is, the sentence combination indicates finding the most probable word string by calculating reliability with respect to each of N candidate words for each section, and by combining a reliability value and a probability value of the language model 461. Here, by effectively applying long-term language information and backward language information together instead of limitedly applying the language model 461 only to the correlation between a preceding word and a following word, it is possible to improve the sentence recognition performance. In step 470, the final sentence recognition result is induced.

Next, a voice recognition method of the voice recognition apparatus 100 will be described. FIG. 5 is a flowchart schematically illustrating a voice recognition method according to an exemplary embodiment of the present invention. Hereinafter, a description will be made with reference to FIGS. 1 to 2D, and FIG. 5.

Initially, the input voice divider 110 divides an input voice into sentence component groups, each group including at least one word (input voice dividing step S500). Input voice dividing step S500 proceeds in an order of a step in which the word extractor 111 sequentially extracts the word from the input voice based on an input order and a step in which the boundary point determining unit 112 determines, as a boundary point, a single point that is positioned between extracted words (above S501), a step in which the boundary point selector 113 selects, from among determined boundary points, a boundary point that matches a predetermined boundary detection model, and a step in which the sentence component group divider 114 divides the input voice into the sentence component groups based on the selected boundary point (above S502), and the like. The boundary point selector 113 may use a noise component or a channel variation component as the boundary detection model.

After input voice diving step S500, the word recognizer 120 recognizes a word included in each group for each divided sentence component group (word recognizing step S510).

Next, the candidate word extractor 130 extracts, from recognized words as a candidate word, a word that matches a sentence configuration word constituting a sentence (candidate word extracting step S520). Candidate word extracting step S520 proceeds in an order of a step in which the reliability calculator 131 calculates a reliability value based on an anti-phoneme model with respect to each of the recognized words (S521), a step in which a determining unit (not shown) compares the calculated reliability value and a reference value and determines whether the reliability value is greater than or equal to the reference value (S522), a step in which the reliability based word extractor 132 extracts, as the candidate word, a word whose calculated reliability value is greater than or equal to the reference value (S523), and the like.

After candidate word extracting step S520, the sentence recognizer 140 performs sentence unit based voice recognition with respect to the input voice based on extracted candidate words (sentence recognizing step S530). Sentence recognizing step S530 may proceed in an order of a step in which the candidate word combiner 141 combines candidate words, a step in which the sentence generator 142 performs the sentence unit based voice recognition with respect to the input voice by generating, as a sentence, a combination that matches a language model based on a sentence configuration principle among combinations, and the like. The step of combining candidate words may proceed in an order of a step in which the candidate word arrangement unit 145 arranges the candidate words based on an extraction order, a step in which the arranged word combiner 146 forward combines the arranged candidate words based on the extraction order, backward combines the arranged candidate words based on the extraction order, combines the arranged candidate words regardless of the extraction order, and the like.

The sentence recognizer 140 performs the sentence unit based voice recognition with respect to the input voice that is consecutively input.

The present invention proposes a hierarchical search structure for sentence unit based voice recognition. The existing proposed recognition method is a sequential recognition method depending on a preceding word, instead of being an area by area recognition process based on a word boundary. Accordingly, in the case that an erroneously recognized and unregistered word is included in the middle of a sentence when determining only a sentence unit based optimal path, it adversely affects the following recognition result. The hierarchical search structure proposed in the present invention determines a word boundary, determines N candidate words in a word unit area, and finally induces a sentence recognition result. Accordingly, the present invention may improve the sentence unit based consecutive voice recognition performance in a large vocabulary voice recognition system and may contribute to the development of infinite natural language voice recognition technology.

The present invention may be applicable to a voice recognition field, for example, a natural language voice recognition field.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for recognizing a voice, comprising:
an input voice divider to divide an input voice into sentence component groups, each group including at least one word;
a word recognizer to recognize a word included in each group for each divided sentence component group;
a candidate word extractor to extract, from recognized words as a candidate word, a word that matches a sentence configuration word constituting a sentence; and
a sentence recognizer to perform sentence unit based voice recognition with respect to the input voice based on extracted candidate words.

2. The apparatus of claim 1, wherein the input voice divider comprises:
a word extractor to sequentially extract the word from the input voice based on an input order;
a boundary point determining unit to determine, as a boundary point, a single point that is positioned between extracted words;
a boundary point selector to select, from among determined boundary points, a boundary point that matches a predetermined boundary detection model; and
a sentence component group divider to divide the input voice into sentence component groups based on the selected boundary point.

3. The apparatus of claim 1, wherein the candidate word extractor comprises:
a reliability calculator to calculate a reliability value based on an anti-phoneme model with respect to each of the recognized words; and
a reliability based word extractor to extract, as the candidate word, a word whose calculated reliability value is greater than or equal to a reference value.

4. The apparatus of claim 1, wherein the sentence recognizer comprises:
a candidate word combiner to combine candidate words; and
a sentence generator to perform the sentence unit based voice recognition with respect to the input voice by generating, as a sentence, a combination that matches a language model based on a sentence configuration principle among combinations of candidate words.

5. The apparatus of claim 4, wherein the candidate word combiner comprises:
a candidate word arrangement unit to arrange the candidate words based on an extraction order; and
an arranged word combiner to forward combine the arranged candidate words based on the extraction order, to backward combine the arranged candidate words based on the extraction order, or to combine the arranged candidate words regardless of the extraction order.

6. The apparatus of claim 2, wherein the boundary point selector uses a noise component or a channel variation component as the boundary detection model.

7. The apparatus of claim 1, wherein the sentence recognizer performs the sentence unit based voice recognition with respect to the input voice that is consecutively input.

8. A method of recognizing a voice, comprising:
an input voice dividing step of dividing an input voice into sentence component groups, each group including at least one word;
a word recognizing step of recognizing a word included in each group for each divided sentence component group;
a candidate word extraction step of extracting, from recognized words as a candidate word, a word that matches a sentence configuration word constituting a sentence; and
a sentence recognizing step of performing sentence unit based voice recognition with respect to the input voice based on extracted candidate words.

9. The method of claim 8, wherein the input voice dividing step comprises:
a word extracting step of sequentially extracting the word from the input voice based on an input order;
a boundary point determining step of determining, as a boundary point, a single point that is positioned between extracted words;
a boundary point selecting step of selecting, from among determined boundary points, a boundary point that matches a predetermined boundary detection model; and
a sentence component group dividing step of dividing the input voice into sentence component groups based on the selected boundary point.

10. The method of claim 8, wherein the candidate word extracting step comprises:
a reliability calculating step of calculating a reliability value based on an anti-phoneme model with respect to each of the recognized words; and
a reliability based word extracting step of extracting, as the candidate word, a word whose calculated reliability value is greater than or equal to a reference value.

11. The method of claim 8, wherein the sentence recognizing step comprises:
a candidate word combining step of combining candidate words; and
a sentence generating step of performing the sentence unit based voice recognition with respect to the input voice by generating, as a sentence, a combination that matches a language model based on a sentence configuration principle among combinations of candidate words.

12. The method of claim 11, wherein the candidate word combining step comprises:
a candidate word arranging step of arranging the candidate words based on an extraction order; and
an arranged word combining step of forward combining the arranged candidate words based on the extraction order, backward combining the arranged candidate words based on the extraction order, or combining the arranged candidate words regardless of the extraction order.

13. The method of claim 9, wherein the boundary point selecting step uses a noise component or a channel variation component as the boundary detection model.

14. The method of claim 8, wherein the sentence recognizing step performs the sentence unit based voice recognition with respect to the input voice that is consecutively input.
